(19) United States
(12) Patent Application Publication
(10) Pub. No.: US 2024/0363971 A1
(43) Pub. Date: Oct. 31, 2024

(54) BATTERY MODULE MANUFACTURING METHOD AND BATTERY MODULE MANUFACTURING APPARATUS

(71) Applicant: SK On Co., Ltd., Seoul (KR)

(72) Inventors: Wook Hyun KIM, Daejeon (KR); Kwan Yong KIM, Daejeon (KR); Yun U CHANG, Daejeon (KR)

(21) Appl. No.: 18/416,888

(22) Filed: Jan. 19, 2024

(30) Foreign Application Priority Data
Apr. 27, 2023 (KR) 10-2023-0055407

(51) Int. Cl. H01M 50/507; H01M 50/204; H01M 50/54

(52) U.S. Cl. CPC H01M 50/507; H01M 50/204; H01M 50/54

(57) ABSTRACT

A battery module manufacturing method comprising according to an embodiment of the present disclosure includes: coupling a guide with cell tabs, the guide aligning the cell tabs of each of a plurality of battery cells with the cell tabs; and coupling a bus bar assembly with the cell tabs, in a direction perpendicular to a direction in which the cell tabs protrude from the battery cells, the bus bar assembly that electrically connects the cell tabs to each other, wherein, while the bus bar assembly is being coupled with the cell tabs, the bus bar assembly pushes out the guide in a direction perpendicular to a direction in which the cell tabs protrude.

### CROSS-REFERENCE TO RELATED PATENT APPLICATION

The present application claims priority under 35 U.S.C. § 119 (a) to Korean patent application number 10-2023-0055407 filed on Apr. 27, 2023, in the Korean Intellectual Property Office, the entire disclosure of which is incorporated by reference herein.

### BACKGROUND OF THE INVENTION

### 1. Field

Embodiments of the present disclosure relate to a battery module manufacturing method and a battery module manufacturing apparatus.

### 2. Description of the Related Art

Recently, secondary batteries are widely used not only in small devices such as mobile electronic devices but also in medium-to-large devices such as automobiles and power storage devices. In particular, as carbon energy is gradually depleted and interest in the environment increases, public attention is focused on hybrid vehicles and electric vehicles around the world, including the United States, Europe, Japan, and Korea.

In these hybrid vehicles and electric vehicles, the most critical component is the battery pack, which provides driving force to the vehicle motor. Since hybrid cars and electric cars may obtain the driving force of the vehicles through charging and discharging of the battery pack, they have a superior fuel efficiency and discharge no pollutants, compared to vehicles using only an engine, and thus the users are gradually increasing to a great number.

In addition, a battery pack used in a hybrid vehicle or electric vehicle includes a battery module including a plurality of battery cells, and as a plurality of battery cells are connected to each other in series and/or in parallel, the capacity and output of a battery module are increased.

Cell tabs are formed on both ends of a battery cell to allow a plurality of battery cells to be electrically connected, and these cell tabs are coupled and welded with a bus bar assembly to maintain a state of being electrically connected.

However, in the cases where the width of slots formed on an earthly strip of a bus bar assembly, through which cell tabs of battery cells pass, is very narrow, and the direction of the cell tabs is slightly distorted due to a cumulative stacking tolerance of cell tabs according to the stacking of battery cells, insertion through the slots may not be performed, and consequently, a fatal problem that a completely assembled battery pack may not function properly may occur.

Furthermore, the problem that cell tabs and battery cells are damaged may occur in the process of coupling cell tabs with a bus bar assembly.

Therefore, there is a need for a new battery module manufacturing method that can minimize damage or deformation of battery cells and cell tabs included therein and at the same time, easily perform the coupling of cell tabs and a bus bar assembly.

### SUMMARY OF THE INVENTION

Embodiments of the present disclosure provide a battery module manufacturing method and a battery module manufacturing apparatus that can minimize damage or deformation of battery cells and cell tabs included therein and at the same time, easily perform the coupling of cell tabs and a bus bar assembly.

A battery module manufacturing method according to an embodiment of the present invention includes: coupling a guide with cell tabs, the guide aligning cell tabs of each of a plurality of battery cells with the cell tabs; and coupling a bus bar assembly, in a direction perpendicular to a direction in which the cell tabs protrude from the battery cells, the bus bar assembly that electrically connects the cell tabs to each other, wherein, while the bus bar assembly is coupled with the cell tabs, the bus bar assembly may push out the guide in a direction perpendicular to a direction in which the cell tabs protrude.

According to one embodiment, as coupling of the bus bar assembly with the cell tabs is completed, the guide may be removed from the cell tabs.

According to one embodiment, wherein coupling the guide with the cell tabs may couple the guide with the cell tabs in a direction parallel to a direction in which the cell tabs protrude from the battery cells.

According to one embodiment, wherein coupling the bus bar assembly with the cell tabs, the bus bar assembly may contact the guide and push out the guide.

According to one embodiment, the guide, in a state where it is coupled with the cell tabs, may be movable in a direction perpendicular to a direction in which the cell tabs protrude.

According to one embodiment, the guide may include a plurality of grooves in which the cell tabs are each accommodated.

According to one embodiment, at least one of the ends of the grooves in a direction perpendicular to a direction in which the cell tabs protrude may be open.

According to one embodiment, the bus bar assembly may include a plurality of opening portions in which the cell tabs may each be accommodated.

According to one embodiment, the plurality of opening portions may have one end open in a direction perpendicular to a direction in which the cell tabs protrude so that the cell tabs may be inserted in a direction perpendicular to a direction in which the cell tabs protrude.

According to one embodiment, the battery cells may be stacked on each other in a direction perpendicular to both a direction in which the cell tabs protrude from the battery cells and a direction in which the bus bar assembly is coupled with the cell tabs.

A battery module manufacturing apparatus according to an embodiment of the present invention includes: a guide aligning cell tabs of each of a plurality of battery cells; a guide coupling portion coupling the guide with the cell tabs; and a bus bar assembly coupling portion coupling with the cell tabs the bus bar assembly that electrically connects the cell tabs, in a direction perpendicular to a direction in which the cell tabs protrude from the battery cells, wherein, while the bus bar assembly is coupled with the cell tabs, the bus bar assembly may push out the guide in a direction perpendicular to a direction in which the cell tabs protrude.

According to one embodiment, as the bus bar assembly is coupled with the cell tabs, the guide may be removed from the cell tabs.

According to the present disclosure, a battery module manufacturing method and a battery module manufacturing apparatus that can minimize damage or deformation of battery cells and cell tabs included therein and at the same time, easily perform the coupling of cell tabs and a bus bar assembly may be provided.

The battery cells included in embodiments of the present disclosure can be widely applied in the field of green technology, such as electric vehicles, battery charging stations, solar power generation, and wind power generation using batteries.

### BRIEF DESCRIPTION OF THE DRAWINGS

FIG. 1 is a flowchart for explaining a battery module manufacturing method according to an embodiment of the present invention.

FIG. 2 is a diagram for explaining configurations used in a battery module manufacturing method according to one embodiment of the present invention.

FIG. 3 is a diagram for explaining a guide used in a battery module manufacturing method according to one embodiment of the present invention.

FIG. 4 is a diagram for explaining a bus bar assembly used in a battery module manufacturing method according to one embodiment of the present invention.

FIG. 5 is a diagram for explaining step S100 of FIG. 1.

FIG. 6 is a diagram for explaining step S200 of FIG. 1.

FIG. 7 is a diagram for explaining what happens after step S200 of FIG. 1 is performed.

FIG. 8 is a diagram for explaining a battery module manufacturing apparatus according to an embodiment of the present invention.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

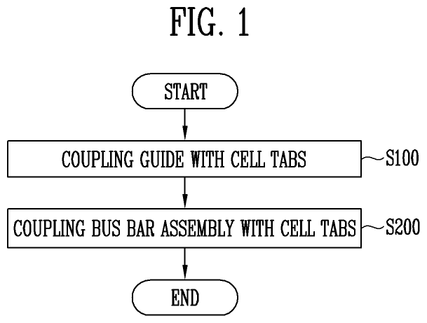

FIG. 1 is a flowchart for explaining a battery module manufacturing method according to an embodiment of the present invention.

Referring to FIG. 1, a guide may be coupled with cell tabs in step S100. A guide may align cell tabs of each of a plurality of battery cells. That is, by aligning cell tabs, a guide may guide the cell tabs so that they may be easily coupled with a busbar assembly in a later step.

In one embodiment, a guide may be coupled with cell tabs in a direction parallel to a direction in which the cell tabs protrude from battery cells.

In another embodiment, a guide may be coupled with cell tabs in a direction perpendicular to a direction in which the cell tabs protrude from battery cells.

In another embodiment, a guide may be coupled with cell tabs to form an angle θ with a direction in which the cell tabs protrude from battery cells, wherein the θ may be 0°<θ<90°.

In other words, an angle at which a guide is coupled with cell tabs may be set in various ways depending on the shape of the guide, and is not limited to a specific angle. However, after coupling, a guide may be coupled with the cell tabs so that it may move in a direction perpendicular to a direction in which the cell tabs protrude.

Next, a busbar assembly may be coupled with cell tabs in step S200. A busbar assembly may electrically connect cell tabs to each other.

In an embodiment, a busbar assembly may be coupled with cell tabs in a direction perpendicular to a direction in which the cell tabs protrude from battery cells.

In an embodiment, while a busbar assembly is coupled with cell tabs in a direction perpendicular to a direction in which the cell tabs protrude from battery cells, the busbar assembly may push out the guide coupled to the cell tabs. That is, a bus bar assembly may push out a guide in a direction perpendicular to a direction in which cell tabs protrude from the battery cells.

In one embodiment, a bus bar assembly may contact a guide in a process of coupling with cell tabs, and a bus bar assembly may contact a guide and push out the guide in a direction in which cell tabs protrude from battery cells. However, a bus bar assembly is not limited to this embodiment, and in another embodiment, an additional configuration may exist between a bus bar assembly and a guide, and as a force transmitted when a bus bar assembly contacts this additional configuration is transmitted to a guide, the guide may be pushed out in a direction in which cell tabs protrude from battery cells.

As a busbar assembly is coupled with cell tabs and pushes a guide, the guide may finally be removed from the cell tabs.

In an embodiment, a step of welding a busbar assembly and cell tabs after the busbar assembly and the cell tabs are coupled may be further included.

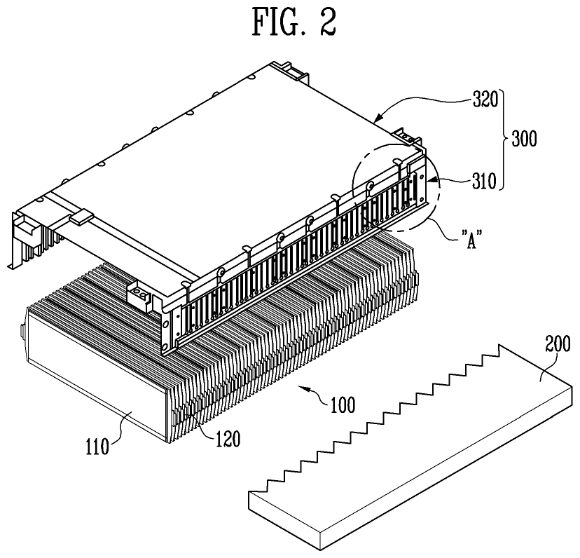

FIG. 2 is a diagram for explaining configurations used in a battery module manufacturing method according to one embodiment of the present invention.

Referring to FIG. 2, a battery module may be manufactured by coupling a bus bar assembly 300 with a battery cell array 100. A battery cell array 100 may include a plurality of battery cells 110.

In an embodiment, each battery cell 110 may include a cathode, an anode, and a separator disposed therebetween.

In an embodiment, a cathode and an anode may each include a current collector and an active material layer disposed on a current collector. For example, a cathode may include a cathode current collector and a cathode active material layer, and an anode may include an anode current collector and an anode active material layer.

A current collector may include a known conductive material to an extent that it does not cause a chemical reaction within a lithium secondary battery.

An active material layer may include an active material, and for example, a cathode active material layer may include a cathode active material, and an anode active material layer may include an anode active material. A cathode active material is a material which lithium (Li) ions may be inserted into and extracted from, and an anode active material is a material which lithium ions may be adsorbed into and extracted from.

In addition, a cathode and an anode may each further include a binder and a conductive material. A binder may improve mechanical stability by mediating a bond between a current collector and an active material layer, and a conductive material may improve electrical conductivity of a lithium secondary battery.

A separator may be disposed between a cathode and an anode. A separator may be configured to prevent electrical short-circuiting between a cathode and an anode and to generate a flow of ions.

According to an embodiment, a separator may include a porous polymer film or a porous non-woven fabric.

Each of a battery cells 110 may include cell tabs 120 protruding from battery cells 110. In the present specification, a direction in which cell tabs 120 protrude from battery cells 110 may be defined as the x-axis direction. Cell tabs 120 illustrated in FIG. 2 are illustrated to protrude from battery cells 110 in both directions of the x-axis, but they are not limited thereto, and cell tabs 120 may protrude only in any one direction of the x-axis.

A battery cell array 100 may consist of a plurality of battery cells 110 stacked on each other. In the present specification, a direction in which battery cells 110 are stacked may be defined as the y-axis direction.

A guide 200 may be used to smoothly couple a bus bar assembly 300 with a battery cell array 100. Before a bus bar assembly 300 is coupled with cell tabs 120, a guide 200 may first be coupled with the cell tabs 120.

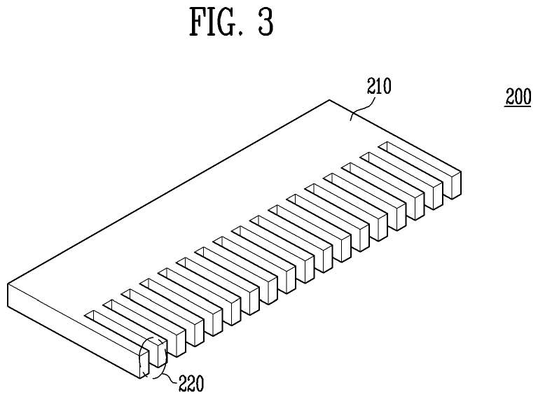

A guide 200 may include a plurality of grooves in which cell tabs 120 may each be accommodated. A guide 200 will be described in more detail in FIG. 3 below.

A bus bar assembly 300 may be coupled with cell tabs 120 in a direction perpendicular to a direction in which the cell tabs 120 protrude from battery cells 110, that is, in a direction perpendicular to the x-axis direction. In the present specification, a direction in which a bus bar assembly 300 is coupled with cell tabs 120 may be defined as the z-axis direction. The x-axis direction, y-axis direction, and z-axis direction defined in the present specification may be orthogonal to each other.

In FIG. 2, since cell tabs 120 protrude from battery cells 110 in both directions of the x-axis, a bus bar assembly 300 may be coupled with all cell tabs 120 to be positioned in both directions of the x-axis of a battery cell array 100. However, in another embodiment, in the case where cell tabs 120 protrude from battery cells 110 in only any one direction of the x-axis, a bus bar assembly 300 may be coupled with cell tabs 120 to be positioned in only any one direction of the x-axis of a battery cell array 100.

A busbar assembly 300 may include a coupling portion 310 coupled with cell tabs 120. In one embodiment, as shown in FIG. 2, in the case where cell tabs 120 protrude from battery cells 110 in both directions of the x-axis, a bus bar assembly 300 may include two coupling portions 310 to be coupled with all cell tabs 120 in both direction.

In another embodiment, in the case where cell tabs 120 protrude from battery cells 110 in only any one direction of the x-axis, a bus bar assembly 300 may include one coupling portion 310 to be coupled with cell tabs 120 in one direction.

In one embodiment, as shown in FIG. 2, a bus bar assembly 300 may include an upper cover 320 for connecting the two coupling portions 310 to each other. However, in another embodiment, a bus bar assembly 300 may consist of only two separate coupling portions 310 without a separate upper cover 320.

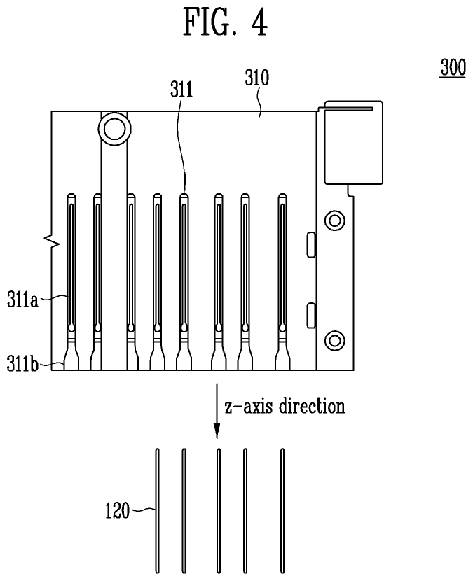

A coupling portion 310 included in a bus bar assembly 300 may include a plurality of opening portions in which cell tabs 120 may each be accommodated. A bus bar assembly 300 will be described in more detail in FIG. 4 below.

FIG. 3 is a diagram for explaining a guide used in a battery module manufacturing method according to one embodiment of the present invention.

Referring to FIG. 3, a guide 200 may include a plate 210 and a plurality of grooves 220 formed in the plate 210.

When a bus bar assembly 300 is coupled with cell tabs 120 after a guide 200 is coupled with the cell tabs 120, a bus bar assembly 300 may contact a plate 210. As a bus bar assembly 300 and a plate 210 contact each other, the bus bar assembly 300 may push out a guide 200 in the z-axis direction.

Grooves 220 may have a concave shape to face each of cell tabs protruding from battery cells. In other words, grooves 220 may have a concave shape in the x-axis direction. For example, a groove 220 may be concave to have a triangular cross-section as illustrated in FIG. 2, or may be concave to have a rectangular cross-section as illustrated in FIG. 3. In another embodiment, a groove 220 may be concave to have a curved cross-section.

One or more cell tabs may be accommodated in each of grooves 220. More specifically, a single call tab may be accommodated in each of grooves 220.

Grooves 220 may be formed to be spaced apart from each other in a predetermined spacing. In an embodiment, a predetermined spacing may be determined according to a spacing between cell taps. For example, a spacing between grooves 220 may be set so that a single cell tab may be inserted into a single groove 220.

In an embodiment, at least one end of grooves 220 in the z-axis direction may be open. Accordingly, after a guide 200 is coupled with cell tabs in the x-axis direction and the cell tabs are accommodated in each groove 220, the guide 200 may be movable in the z-axis direction. More specifically, after cell tabs are accommodated in each groove 220, while a bus bar assembly is coupled with the cell tabs in the z-axis direction, the bus bar assembly pushes out a guide 200 in the z-axis direction so that the guide 200 may move in the z-axis direction.

FIG. 4 is a diagram for explaining a bus bar assembly used in a battery module manufacturing method according to one embodiment of the present invention.

As shown in FIG. 2, a bus bar assembly 300 may include a coupling portion 310, and FIG. 4 shows an enlarged diagram of portion A of a coupling portion 310 illustrated in FIG. 2.

Referring to FIG. 4, a coupling portion 310 may include a plurality of opening portions 311 in which cell tabs 120 may each be accommodated.

Opening portions 311 may be formed in the shape of long holes with a predetermined length along the z-axis direction so that cell tabs 120 may be accommodated therein.

In an embodiment, one end of opening portions 311 in the z-axis direction may be open. As one end of opening portions 311 in the z-axis direction is opened, cell tabs 120 may be inserted into the opening portions 311 in the z-axis direction.

As such, one open end of an opening portion 311 may be an insertion portion 311b. An insertion portion 311b may be a part where a cell tab 120 first enters into an opening portion 311.

Additionally, the other end of opening portions 311 in the z-axis direction may be closed. In this way, the other closed end of an opening portion 311 may be a fixing portion 311a. A fixing portion 311a may be a part where a cell tab 120 that enters into an opening portion 311 is fixed.

In one embodiment, the width of insertion portions 311b may be larger than the width of fixing portions 311a so that cell tabs 120 may easily enter into opening portions 311.

As a bus bar assembly 300 moves toward cell tabs 120 in the z-axis direction, the cell tabs 120 enter into opening portions through insertion portions 311b of each of the opening portions 311, and as the cell tabs 120 are fixed to fixing portions 311a, a bus bar assembly 300 and cell tabs 120 may be coupled.

Opening portions 311 may be formed to be spaced apart from each other in a predetermined spacing. In an embodiment, a predetermined spacing may be determined according to a spacing between cell taps. For example, a spacing between grooves 220 may be set so that a single cell tab may be inserted into a single opening portion 311.

In an embodiment, a spacing between opening portions 311 may correspond to a spacing between grooves of a guide. For example, a spacing between openings portions 311 may be the same as a spacing between grooves of a guide, and accordingly, cell tabs 120 aligned by a guide may be easily inserted into the opening portions 311.

In addition, when coupling a bus bar assembly 300 with cell tabs 120, the cell tabs 120 aligned by a guide may each be positioned within the width of an insertion portion 311b of an opening portion 311. Therefore, even when there is a slight mismatch between the positions of cell tabs 120 aligned by a guide and fixing portions 311a of opening portions 311, due to the presence of insertion portions 311b having a relatively wide width, call tabs 120 may be inserted into fixing portions 311a included in opening portions 311.

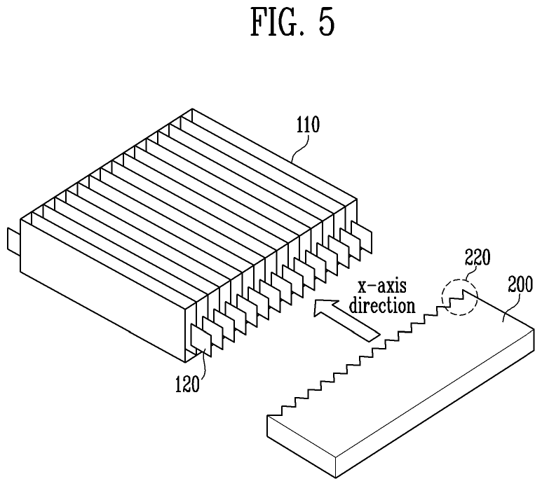

FIG. 5 is a diagram for explaining step S100 of FIG. 1.

Referring to FIG. 5, a guide 200 may be coupled with cell tabs 120 of battery cells 110. In one embodiment, as shown in FIG. 5, a guide 200 may be coupled with cell tabs 120 in the x-axis direction, but a coupling direction of a guide 200 and cell tabs 120 is not limited to a specific direction.

As a guide 200 is coupled with cell tabs 120 of battery cells 110, the cell tabs 120 may each be accommodated in grooves 220 of the guide 200.

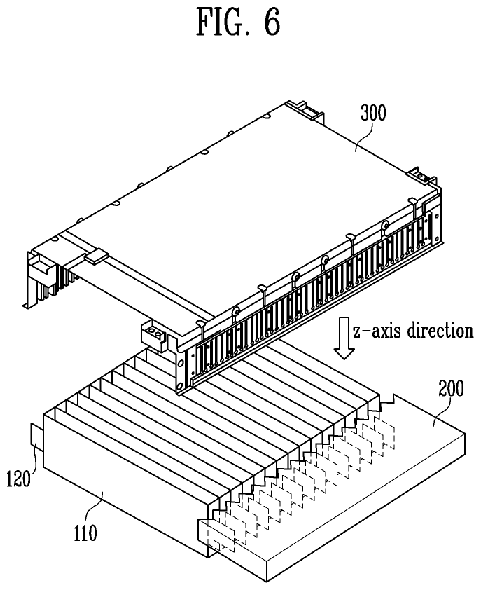

FIG. 6 is a diagram for explaining step S200 of FIG. 1.

Referring to FIG. 6, in a state where a guide 200 is coupled with cell tabs 120, a busbar assembly 300 may be coupled with the cell tabs 120. In an embodiment, a busbar assembly 300 may be coupled with cell tabs 120 in the z-axis direction.

More specifically, a bus bar assembly 300 may move toward cell tabs 120 in the z-axis direction, and cell tabs 120 aligned by a guide 200 may be inserted into opening portions of a bus bar assembly 300.

As a bus bar assembly 300 is coupled with cell tabs 120 in the z-axis direction, the bus bar assembly 300 and a guide 200 may contact each other. More specifically, one cross-section of a bus bar assembly 300 in the z-axis direction and one cross-section of a guide 200 in the z-axis direction may contact each other.

As a bus bar assembly 300 and a guide 200 contact each other, the bus bar assembly 300 may push out the guide 200 in the z-axis direction. More specifically, a guide 200 may receive a force in the z-axis direction by a bus bar assembly 300 and move in the z-axis direction by the force in the z-axis direction.

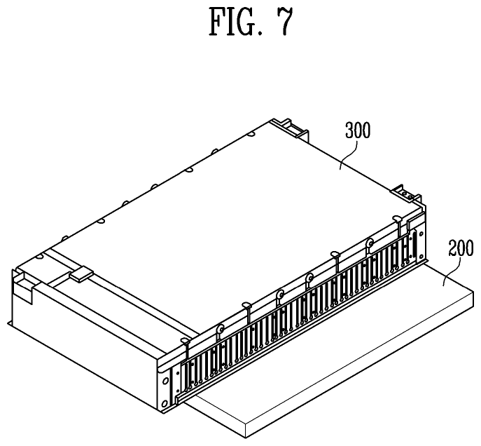

FIG. 7 is a diagram for explaining what happens after step S200 of FIG. 1 is performed.

Referring to FIG. 7, it can be seen that as the bus bar assembly 300 in FIG. 6 is coupled with cell tabs 120 in the z-axis direction, a guide 200 is pushed out in the z-axis direction.

When coupling of a bus bar assembly 300 to cell tabs 120 is completed, that is, when cell tabs 120 are fixed by being positioned on a fixing portion of a bus bar assembly 300, a guide is may be removed from the cell tabs 120.

Therefore, a guide 200 is only used during a manufacturing process of a battery module, and a guide 200 may not be included in a finally manufactured battery module.

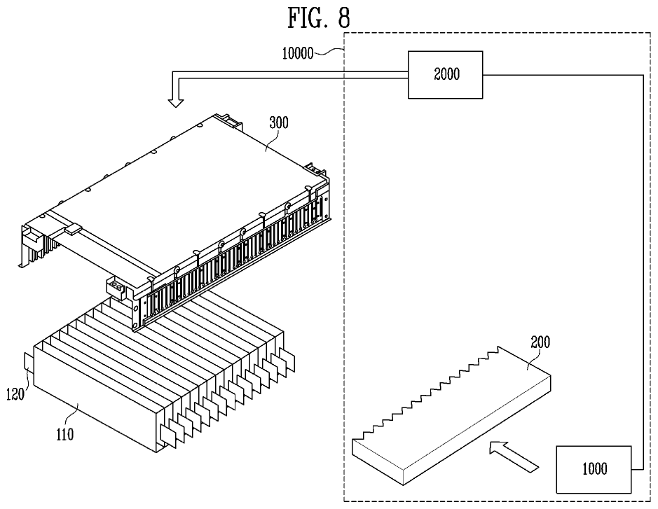

FIG. 8 is a diagram for explaining a battery module manufacturing apparatus according to an embodiment of the present invention.

Referring to FIG. 8, a battery module manufacturing apparatus 10000 may include a guide 200, a guide coupling portion 1000, and a bus bar assembly coupling portion 2000.

A guide 200 is the same as the guide 200 described in FIGS. 2 and 3, and may align cell tabs 120 of each of a plurality of battery cells 110.

A guide 200 may include a plate and a plurality of grooves formed in the plate. Grooves may form a concave shape to each face cell tabs protruding from battery cells. One or more cell tabs may be accommodated in each groove.

A guide coupling portion 1000 may couple a guide 200 with cell tabs 120. In an embodiment, a guide coupling portion 1000 may transfer a guide 200 toward cell tabs 120. For example, a guide coupling portion 1000 may transfer a guide 200 in the x-axis direction so that the guide 200 may be coupled to cell tabs 120, but a coupling direction of a guide 200 and cell tabs 120 is not limited to a particular direction.

In an embodiment, after a guide 200 is coupled with cell tabs 120, a guide coupling portion 1000 may be separated from the guide 200.

A bus bar assembly coupling portion 2000 may couple a bus bar assembly 300 to cell tabs 120. A bus bar assembly 300 is the same as the bus bar assembly 300 described in FIGS. 2 and 4, and may electrically connect cell tabs 120 to each other.

In an embodiment, a busbar assembly coupling portion 2000 may transfer a busbar assembly 300 toward cell tabs 120. A bus bar assembly coupling portion 2000 may transfer a bus bar assembly 300 in the z-axis direction so that the bus bar assembly 300 may be coupled with cell tabs 120 in the z-axis direction.

In an embodiment, when a busbar assembly 300 is coupled with cell tabs 120 in the z-axis direction, the busbar assembly 300 may push out in the z-axis direction a guide 200, which has already been coupled with the cell tabs 120.

In a process of coupling a bus bar assembly 300 to cell tabs 120, a bus bar assembly 300 may continuously push out a guide 200 in the z-axis direction, and when the bus bar assembly 300 is completely coupled to cell tabs 120, the guide 200 may be removed from the cell tabs 120.

In an embodiment, after a bus bar assembly 300 is coupled with cell tabs 120, a bus bar assembly coupling portion 2000 may be separated from the bus bar assembly 300.

In one embodiment, a battery module manufacturing apparatus 10000 may further include a base portion on which a battery cell array 100 including battery cells 110 is disposed. In addition, in one embodiment, a base portion may further include a fixing means for fixing a battery cell array 100.

What is claimed is:

1. A battery module manufacturing method comprising:
coupling a guide with cell tabs, the guide aligning the cell tabs of each of a plurality of battery cells with the cell tabs; and
coupling a bus bar assembly with the cell tabs, in a direction perpendicular to a direction in which the cell tabs protrude from the battery cells, the bus bar assembly that electrically connects the cell tabs to each other,
wherein, while the bus bar assembly is being coupled with the cell tabs, the bus bar assembly pushes out the guide in a direction perpendicular to a direction in which the cell tabs protrude.

2. The battery module manufacturing method according to claim 1, wherein, as coupling of the bus bar assembly with the cell tabs is completed, the guide is removed from the cell tabs.

3. The battery module manufacturing method according to claim 1, wherein coupling the guide with the cell tabs couples the guide with the cell tabs in a direction parallel to a direction in which the cell tabs protrude from the battery cells.

4. The battery module manufacturing method according to claim 1, wherein in coupling the bus bar assembly with the cell tabs, the bus bar assembly contacts the guide and pushes out the guide.

5. The battery module manufacturing method according to claim 1, wherein the guide, in a state where it is coupled with the cell tabs, is movable in a direction perpendicular to a direction in which the cell tabs protrude.

6. The battery module manufacturing method according to claim 5, wherein the guide includes a plurality of grooves in which the cell tabs are each accommodated.

7. The battery module manufacturing method according to claim 6, wherein at least one of the ends of the grooves in a direction perpendicular to a direction in which the cell tabs protrude is open.

8. The battery module manufacturing method according to claim 1, wherein the bus bar assembly includes a plurality of opening portions in which the cell tabs may each be accommodated.

9. The battery module manufacturing method according to claim 8, wherein the plurality of opening portions have one end open in a direction perpendicular to a direction in which the cell tabs protrude so that the cell tabs are inserted in a direction perpendicular to a direction in which the cell tabs protrude.

10. The battery module manufacturing method according to claim 1, wherein the battery cells are stacked on each other in a direction perpendicular to both a direction in which the cell tabs protrude from the battery cells and a direction in which the bus bar assembly is coupled with the cell tabs.

11. A battery module manufacturing apparatus comprising:
a guide aligning cell tabs of each of a plurality of battery cells; a guide coupling portion coupling the guide to the cell tabs; and
a bus bar assembly coupling portion coupling with the cell tabs the bus bar assembly that electrically connects the cell tabs, in a direction perpendicular to a direction in which the cell tabs protrude from the battery cells,
wherein, while the bus bar assembly is coupled with the cell tabs, the bus bar assembly pushes out the guide in a direction perpendicular to a direction in which the cell tabs protrude.

12. The battery module manufacturing apparatus according to claim 11, wherein, as the bus bar assembly is coupled with the cell tabs, the guide is removed from the cell tabs.
